(19) United States
(12) Patent Application Publication
(10) Pub. No.: US 2004/0246197 A1
(43) Pub. Date: Dec. 9, 2004

(54) Three-way office

(76) Inventor: Wanda Jane Barrier, Pleasanton, TX (US)

Correspondence Address: Theresa M. Seal, Esq., 332 Academy Street, Carnegie, PA, 15106, US

(21) Appl. No.: 10/454,243

(22) Filed: Jun. 5, 2003

(51) Int. Cl. G09G 5/00

(52) U.S. Cl. 345/1.1

(57) ABSTRACT

A multiple screen computer system includes three separate screens disposed in a side-by-side vertical orientation on one monitor with the screens being accessible independent of each other and capable of displaying information, graphics, and data independent and simultaneous of each other for providing the user with enhanced multitasking capabilities.

### FIELD OF THE INVENTION

The present invention relates to computer systems, and, more specifically, relates to a computer system utilizing multiple screens on a single monitor that can be simultaneously accessed and interfaced.

### BACKGROUND OF THE INVENTION

The advent and proliferation of sophisticated computer operating systems and accompanying software, most notably the many versions of Microsoft's Windows, has popularized the use of graphical displays generically referred to as windows that can successively appear on the screen of the computer monitor for interface by the user or operator. Although a number of windows can be activated by the user for display on the monitor, only one window is fully viewable to the user at one time with the other windows being partially or totally obscured by the active window. While screen size can be maximized or minimized, this doesn't obviate the shortcoming of being able to interact with only one active window at a time.

The growth of the Internet has only compounded the problem of being limited to interfacing with only one screen at a time. Each specifically created site on the Internet is called a website, and each website displays a viewable first screen referred to as a home page. The home page includes links and pointers to subsequent pages—sites—or to other websites. Nonetheless only one page at a time is distinctly viewable by the user. This is a tremendous inconvenience in so far as the user often must assess, review, compare and integrate information on numerous linked web pages, only one of which is fully viewable. Thus, the user must navigate back and forth between web pages in order to access information from that website.

The prior art discloses a number of devices and systems providing the user with more than one active frame or window to interface with.

The Pike patent (U.S. Pat. No. 4,555,775) discloses a graphic terminal that includes bitmap layers—windows—that are always active although only one layer is fully visible on the screen with the other layers being partially or totally obscured.

The Piech et al. patent (U.S. Pat. No. 5,442,744) discloses a display and editing system that presents three different multimedia displays to the user on one screen: a video viewing player subscreen; a story board subscreen; and a viewer display subscreen for editing the beginning and ending points of multimedia tracks.

The Vigneaux et al. patent (U.S. Pat. No. 5,852,435) discloses a newsroom multimedia production system that includes a journalist workstation that can access and digitize videos frames to varying degrees of resolution for creating a storyboard.

Nonetheless, despite the ingenuity of the above devices, there remains a need for a system having the capability of displaying fully viewable multimedia information and graphics simultaneously on more than one computer monitor screen.

### SUMMARY OF THE INVENTION

The present invention comprehends a computer monitor having multiple, separate screens for providing the user with a three-way office multimedia capability. The computer monitor having multiple screens includes a mousepad and keyboard for interacting with the computer, a CPU having a high-speed modem for communicating with the multiple monitor, and the multiple monitor specifically including an oversized computer monitor screen divided into three separate vertical sections accessible independent of each other. The multiple screen computer system would also include a printer interfaced with each monitor.

It is an objective of the present invention to provide a multiple screen computer system for allowing multi-tasking simultaneously on the three screens of one computer monitor.

It is another objective of the present invention to provide a multiple screen computer system that allows for simultaneous research, comparison and combination of data and information on all computer screens.

It is still another objective of the present invention to provide a multiple screen computer system that expedites the work performed by and on the screens of the system.

It is yet another objective of the present invention to provide a multiple screen computer system that is adaptable for a flat screen monitor.

It is still yet another objective of the present invention to provide a multiple screen computer system wherein a separate document can be displayed on each distinct screen.

Yet another objective of the present invention is to provide a multiple screen computer system wherein one screen could display a document, the second screen could display a page from a website, and the third screen could display incoming e-mail.

Yet still another objective of the present invention is to provide a multiple screen computer screen that obviates the necessity of closing out one screen before moving to the next screen by using three separate screens built into one oversize and customized computer monitor.

These and other objects, features, and advantages will become apparent to one skilled in the art upon a perusal of the following detailed description of the preferred embodiment and the accompanying drawings.

### BRIEF DESCRIPTION OF THE DRAWINGS

FIG. 1 is a perspective view of the multiple screen computer system of the present invention illustrating several peripherals accompanying the system;

FIG. 2 is a bottom plan view illustrating the multiple screen computer system shown first in FIG. 1;

FIG. 3 is a front elevational view of the multiple screen computer system illustrating one layout of the multiple computer screens; and

FIG. 4 is a front elevational view of the multiple screen computer system illustrating a second layout of the multiple computer screens.

### DETAILED DESCRIPTION OF THE PREFERRED EMBODIMENT

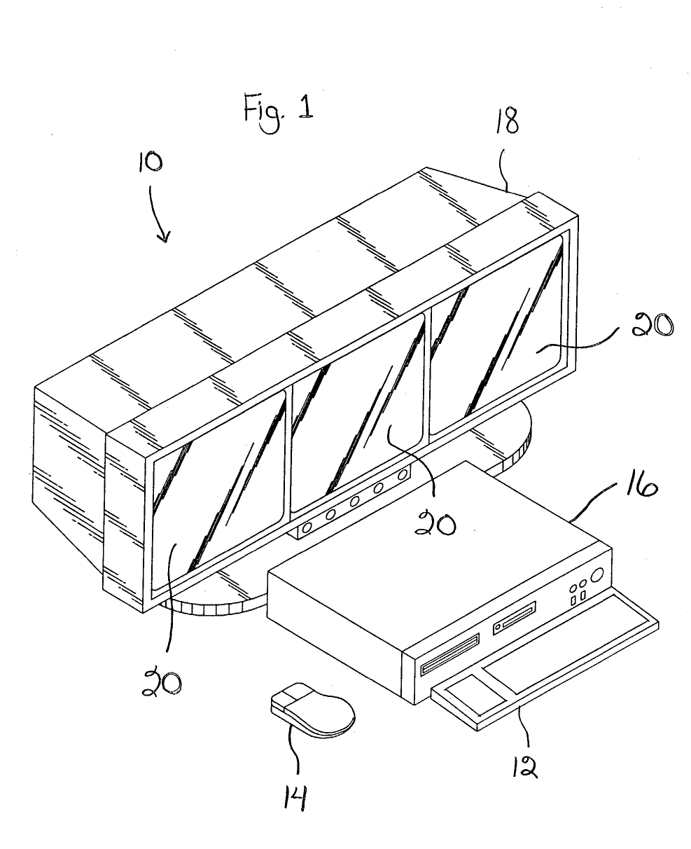

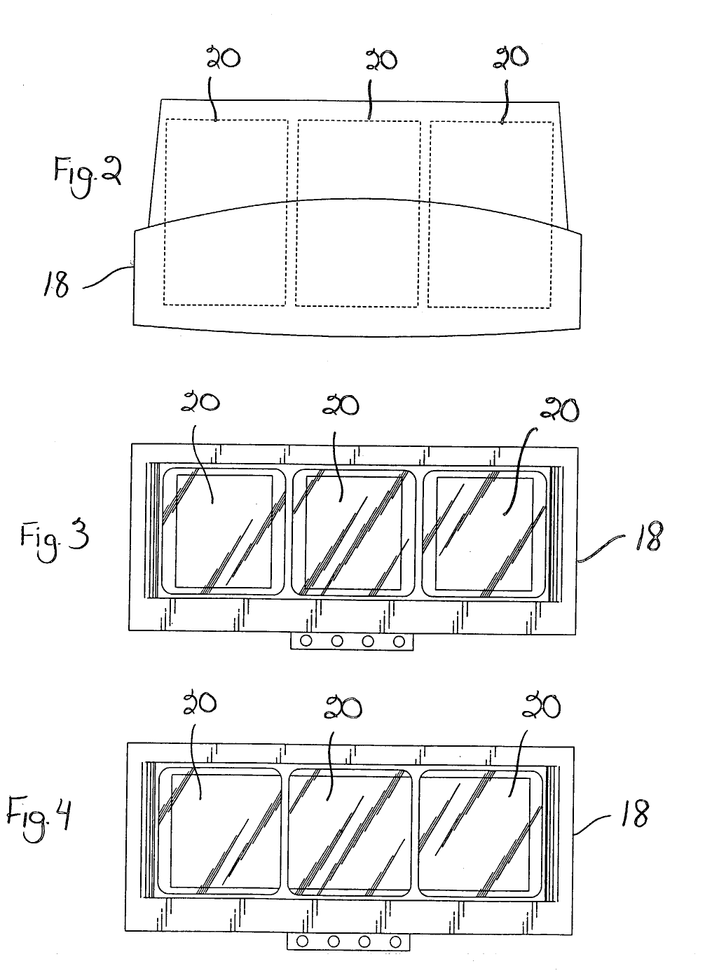

Illustrated in FIGS. 1-4 is a multiple screen computer system 10 that enables a user to simultaneous interface and interact with multiple screens upon which can be displayed, for example, information and data from e-mails, spreadsheets, web pages from the internet and word processing documents. Thus, with the multiple screen computer system 10 the user can call up web pages from a web site on one screen, scan recent emails on a second screen, and balance a checkbook register on a third screen.

As shown in FIG. 1 the elements of the multiple screen computer system 10 include a keyboard 12 and a mouse pad 14 for interfacing and communicating with a CPU 16 that includes a built-in high speed modem. Also shown in FIGS. 1-4 is a customized computer monitor 18 comprising and divided into three separate monitor screens 20. Utilizing three separate computer monitor screens 20 provides the user with enhanced data base access and analysis, comparison viewing of information, data, and graphics displayed on each screen 20, and enhanced research and multi-tasking capabilities. Furthermore, all three screens 20 can be opened simultaneously by the user for performing distinct operations and functions.

As a representative example, the Windows operating system and software versions permit a computer to use more than one monitor. This requires the use of two or more video cards and monitors linked together to form one large Windows desktop. For example, Windows 98 supports multiple monitors by the use of more than one video card while Windows 95 can support multiple monitors through the use of dual or quad-head video cards. However, not all video cards are configured to support multiple monitors and thus their specifications must be confirmed before installation and loading. One method for setting up multiple monitors is to employ a single video card with multiple outputs (multiple heads); this method minimizes compatibility problems although it can be more expensive.

The foregoing description discloses and describes a preferred embodiment of the invention, and those skilled in the art will understand that other variations and modifications are possible and practicable, and still come within the ambit of the invention.

I claim:

1. A multiple screen computer system, comprising:
a CPU;
a keyboard for interfacing with the CPU;
a computer monitor having three separate screens with each screen capable of displaying information, data and graphics simultaneous and independent of the information, data and graphics being displayed on the other screens;
a mouse pad interfaced with the monitors and the CPU for opening, manipulating and closing the various screens displayed on the monitor; and
a printer interfaced with the CPU for printing out in a tangible form the information, data and graphics displayed on the respective screens.

2. The multiple screen computer system of claim 1 wherein at least one of the screens can display e-mail messages being downloaded independent of and simultaneous with the activity occurring on the other screens.

3. The multiple screen computer system of claim 2 wherein at least one of the screens can display web sites and web pages independent and simultaneous of the activity occurring on the other screens.
